(19) United States
(12) Patent Application Publication
(10) Pub. No.: US 2021/0213640 A1
(43) Pub. Date: Jul. 15, 2021

(54) ENVIRONMENTALLY FRIENDLY OLIVE LEAF PANELS

(71) Applicants: Alexandra MAKRYGEORGOU, Kato Ovria Patra (GR); Christos PROPOULOS, Kato Ovria Patra (GR)

(72) Inventors: Alexandra MAKRYGEORGOU, Kato Ovria Patra (GR); Christos PROPOULOS, Kato Ovria Patra (GR)

(21) Appl. No.: 15/734,267

(22) PCT Filed: May 29, 2019
(86) PCT No.: PCT/GR2019/000038

§ 371 Date: Dec. 2, 2020

(30) Foreign Application Priority Data
Jun. 5, 2018 (GR) 20180100243

(51) Int. Cl. B27N 1/02; B27N 3/02; E04C 2/16

(52) U.S. Cl. CPC B27N 1/02; E04C 2/16; B27N 3/02

(57) ABSTRACT

It is the creation of a new material derived from a mixture of renewable natural raw materials, i.e. dried leaves (whole and/or broken—crushed and/or powdered (granulated)) olives (whole and/or part of it and/or specific varieties), as well as inorganic and/or organic and/or synthetic adhesives. The whole mixture that is created undergoes some kind of pressure—depending on its use. Not only can it be used throughout the process but it can also function as a substrate—of varied materials—in all dimensions and shapes. The invention is a new environmentally friendly-partially or fully biodegradable-material that boasts great mechanical strength and resistance to ultraviolet radiation and moisture. This invention has the potential to be used as a flat and/or a three-dimensional surface (substrate part and/or entirely) in goods, works, products and structures for interior and/or exterior use, as a decorative material, a fine art and aesthetic material as well as for the manufacture of objects (general and/or special use).

This invention focuses on the production of flat or/and three-dimensional panels made from the olive leaf biomass (FIG. 1).

### Clarifications of Terminology—Concepts

The aforementioned terms, as well as the concepts referred to in the present invention, specify the following:

a) The term “panel” includes both flat surfaces and three dimensional surfaces (3D—3 Dimensional).

b) The term olive tree (Elaea, Olea) refers to the fruit tree of the Oleaceae family and includes all and/or part and/or a specific variety (e.g. Olea sylvestris) European {Olea europaea}, Spanish {Olea hispanica}, etc.)

c) The term olive leaves refers to dried, green and/or dead olive leaves.

d) The composition of the mixture is basically whole and/or broken—crushed and/or powdered olive leaves (granules).

Therefore, it is not necessary to completely refer to the term unless the inventors wishes to specify a particular feature.

### CLARIFICATIONS OF FIGURES

FIG. 1: Panels made of a mixture of olives leaves, moisture and inorganic and/or organic adhesives (1).

FIG. 2: Panels made of a mixture of olives leaves, moisture and inorganic and/or organic and/or synthetic adhesives (1) with a custom-designed or three dimensional surface (2).

FIG. 3: Olive leaf panels with a custom-designed or three dimensional surface at the top (2) and having a substrate base (3) for the mixture (1).

FIG. 4: Olive leaf panels with a custom-designed or three dimensional surface at the top (2) with a mixture underneath (1) in which there is an integrated substrate (3).

FIG. 5: Olive Leaf Panels with a substrate, where all the mixture (1) is supported either on the top or the bottom (3).

FIG. 6: Olive Leaf Panels wherein the mixture (1) constitutes the upper and lower surfaces within which there is an integrated substrate (3).

FIG. 7: Olive Leaf Panels in which the entire mix (1) is in the substrate (3).

FIG. 8: Olive leaf panels with a designed or three dimensional surface at the top (2) and having a perimeter substrate (3) for the mixture (1).

FIG. 9: Indicative way of washing the olive leaves.

I: Leaves placing
II: Stirring propeller
III: Automatic drainage system
IV: Use of clean water
V: Usage of decontamination substance
VI: Moving motion
VII: Automatic leaf extraction

FIG. 10: Indicative way of drying the olive leaves.

I: Moving motion
II: Digital equalizer
III: Air alternator
IV: air inlet/temperature measurement hole
V: Drying mechanism
VI: Air control mechanism
VII: Heat control mechanism
VIII: Control panel
IX: Import of lugs in order to be dried
X: Layer of olive leaves in a steel lug

### The Eco-Friendly Olive Leaf Panel

The need for innovative and environmentally friendly materials both in the packaging industry as well as in the construction field of furnishing—architecture—decoration—food and beverage service and so on is of immense importance and it calls for the creation of corresponding materials.

Olive and its derivatives have been known since antiquity for their high nutritional value and beneficial therapeutic properties. Also, olive is considered to be a sacred symbol of culture, peace (Olympic Games), prosperity, longevity, and fair playing. Additionally, the existence of numerous sclereids within the olive leaf (mesophyll) gives it additional mechanical resilience.

The material is basically a mixture of renewable natural raw ingredients, that is dried olives, moisture, as well as organic and/or inorganic and/or synthetic adhesive substances.

The percentage of these substances in the mixture that is produced in order to make the final innovative material may vary, depending on the use, the purpose of the creation, the existence or not of the substrate and the properties (durability, resilience, etc.) desired by the end user.

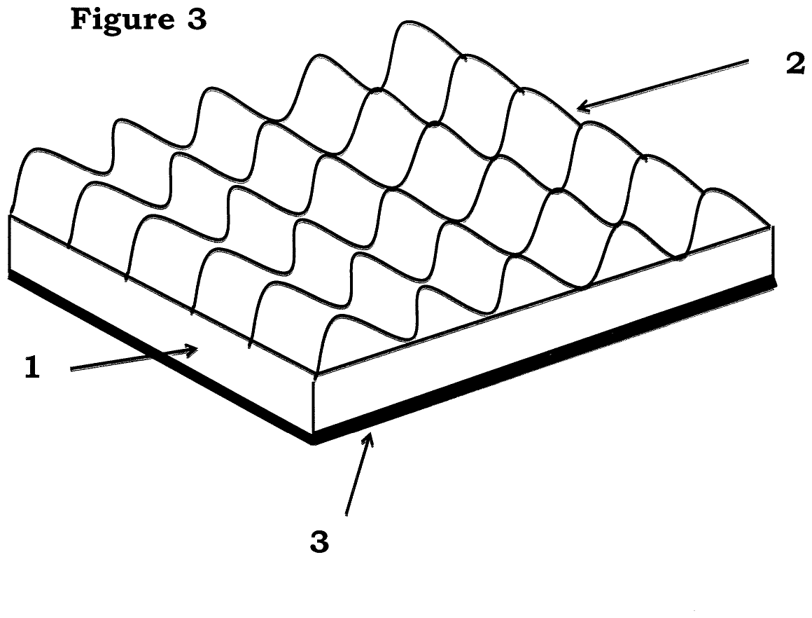

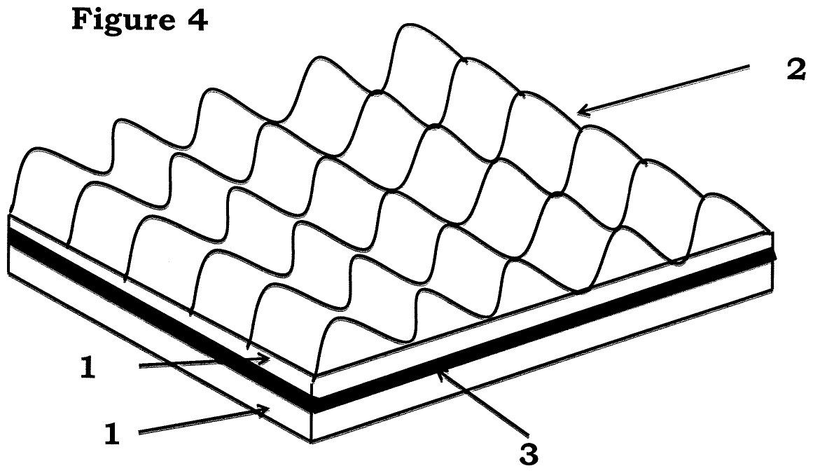

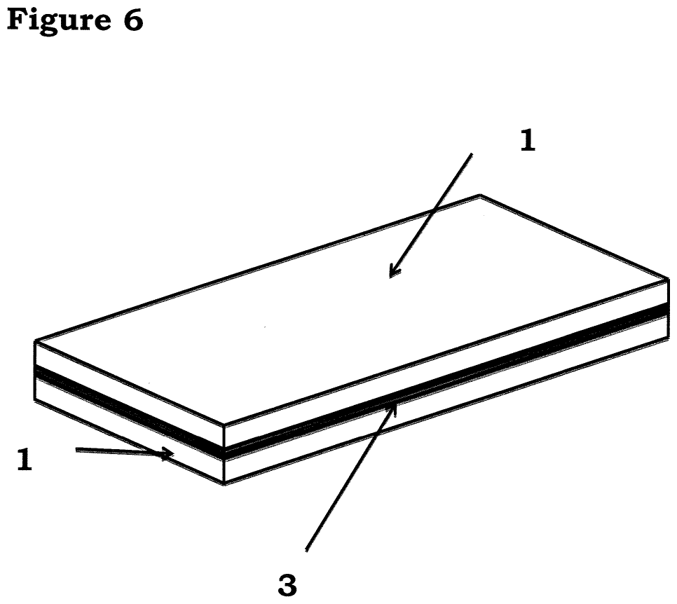

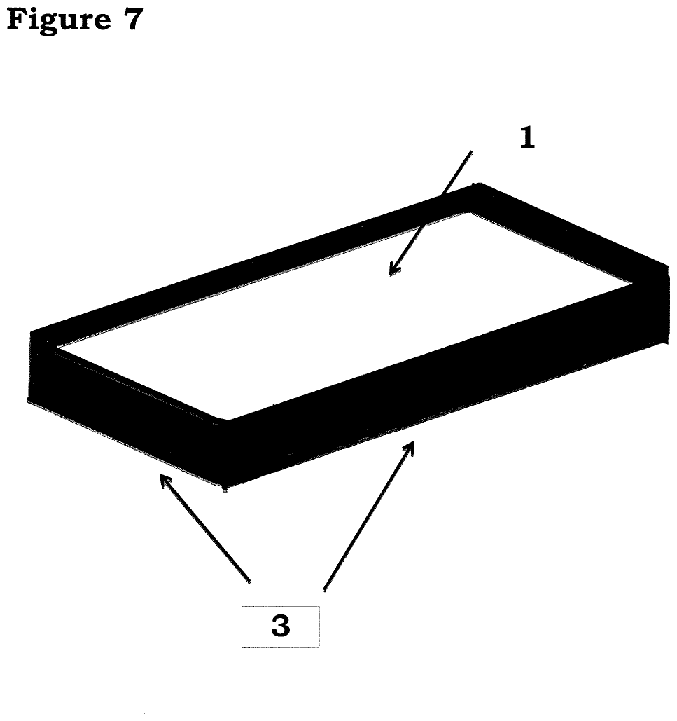

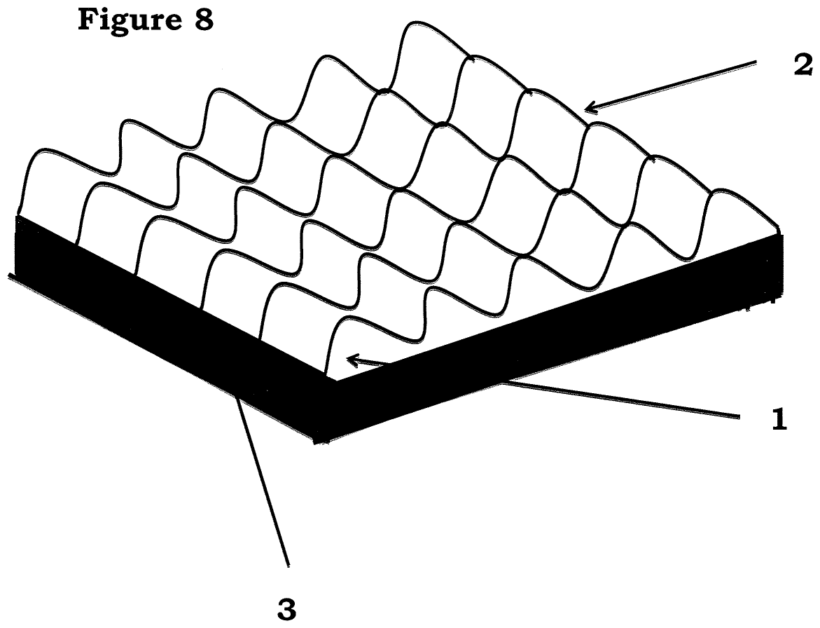

In addition, depending on the requirements, a substrate of a wide variety of materials (wood, resin, metal, other minerals, plastic, synthetic, fabric, etc.) can be used in the production process, which can be placed as a base (FIG. 3, 5), and/or intermediate (FIG. 4, FIG. 6) and/or around the mixture (FIG. 7, FIG. 8).

### The Novelty of the Invention and its Comparative Advantages

Most of the existing commercial panels on the market are not environmentally friendly and none of them contains olive leaves. The novelty and ingenuity of this new material lies—above all—in the use of renewable and recyclable natural raw materials; namely, olive leaves.

A further comparative advantage of the present invention is its ecological quality as it is environmentally friendly in its use, partially or completely biodegradable, while in its production process no solid, liquid or gaseous waste is produced in order to avoid environmental degradation.

In addition, raw materials (e.g. wood) are not destroyed. Likewise, certain methods (e.g. mining and processing of ores) that contribute partially or completely (depending on the circumstances—materials) to the degradation of the environment are not used. In fact, through this procedure untapped raw materials are recycled (olive leaves which are discarded during the process of collecting olive oil and its derivatives).

Then, as aforementioned, since its production process is distinguished by the speed of its stages, it also contributes to the saving of energy resources.

In conclusion, the cultural significance of the olive tree, its derivatives and its leaves on a global scale adds great added value to the wide variety of products that can be created thanks to this new material.

### Application of the New Material

The application of this new material due to its comparative advantages, its properties (natural—artificial) as well as its innovative nature, as summarized above, can apply to most of the existing branches of industry, craft, trade, or even in developing ones. In particular, it can be applied to sectors, such as furnishing, biosynthetics, insulation, construction, jewelry, shipping, medicine, architecture, catering, bicycles, hotels, automotive, clothing, footwear, transport, packaging, robotics, composite materials etc.

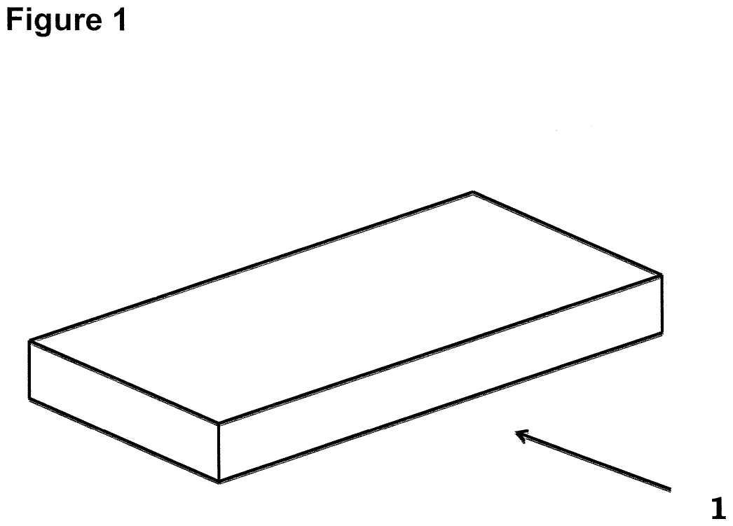

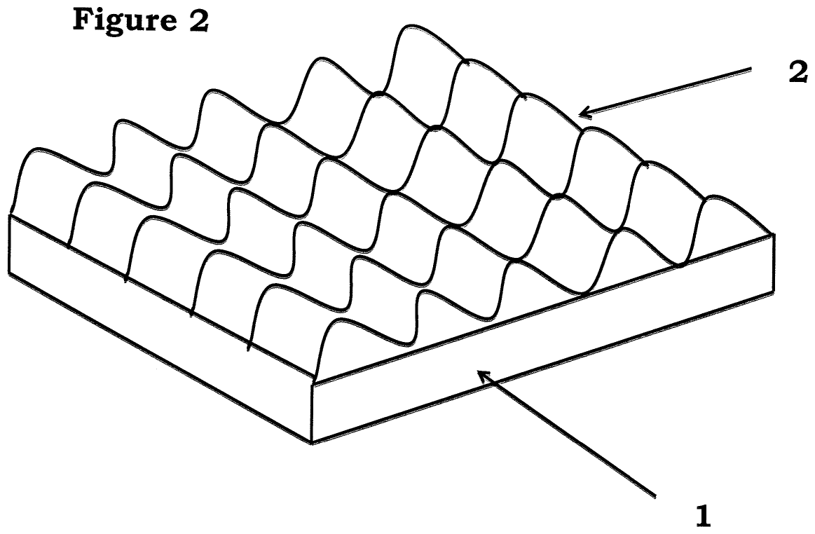

This new material can be used as a flat (FIG. 1) and/or three-dimensional surface (FIG. 2) (part-substrate and/or entirely) in constructions, lining of interior and/or exterior areas, as a decorative material and in the manufacture of objects (general and/or specific use).

### DESCRIPTION OF THE INVENTION

The process of making a surface (flat and/or three-dimensional) of Olive leaves is as follows:

We collect the renewable and untapped natural raw material—olive leaves—primarily from the quantities discarded when collecting the olive oil and its derivatives either immediately after the harvest; thus having green leaves or later on, thus having dead leaves.

This raw material is placed in a washing machine in order to be washed and cleaned.

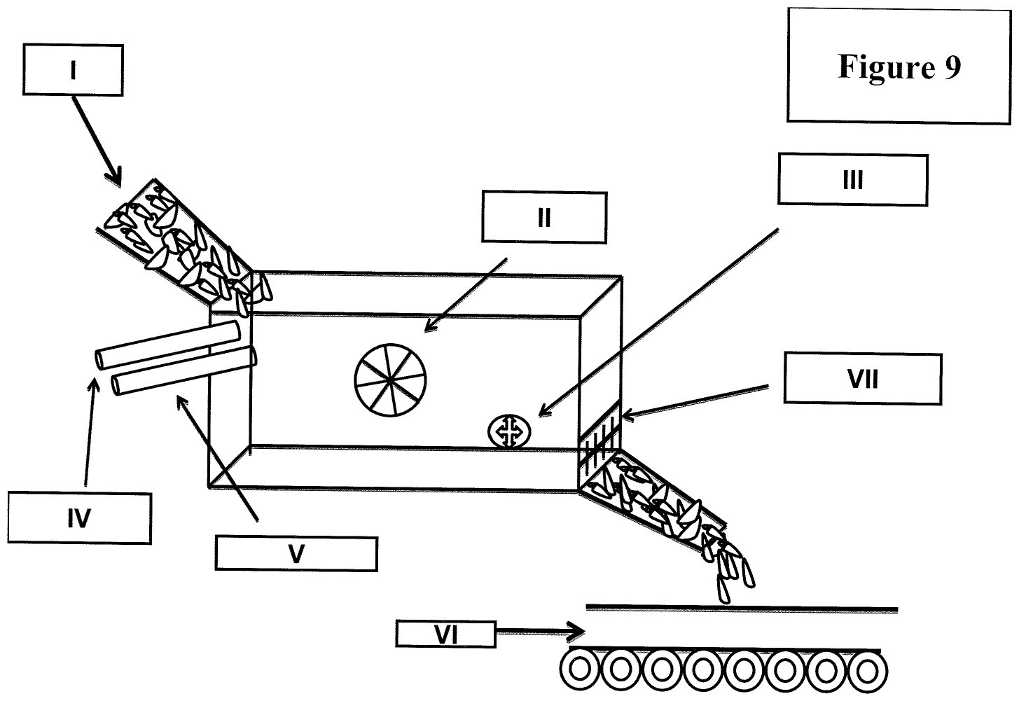

This stage can be carried out by any means while using water at the same time and possibly being under pressure. Advantageously, this stage can be implemented by immersing the olive leaf biomass in a water body which is rapidly moving due to the use of compressed air (FIG. 9).

After washing and removing any additional elements (dust, dirt, stones, inorganic residues, etc.), we pipe it into a dryer.

The drying of olive leaves (desirable humidity below 10%) can be carried out by using any means which allows drying and/or dehumidification.

A simple way of drying the olive leaf biomass can be the Air Drying.

Another way is to pipeline the olive leaf biomass to flash driers and even use Vacuum or Solar drying.

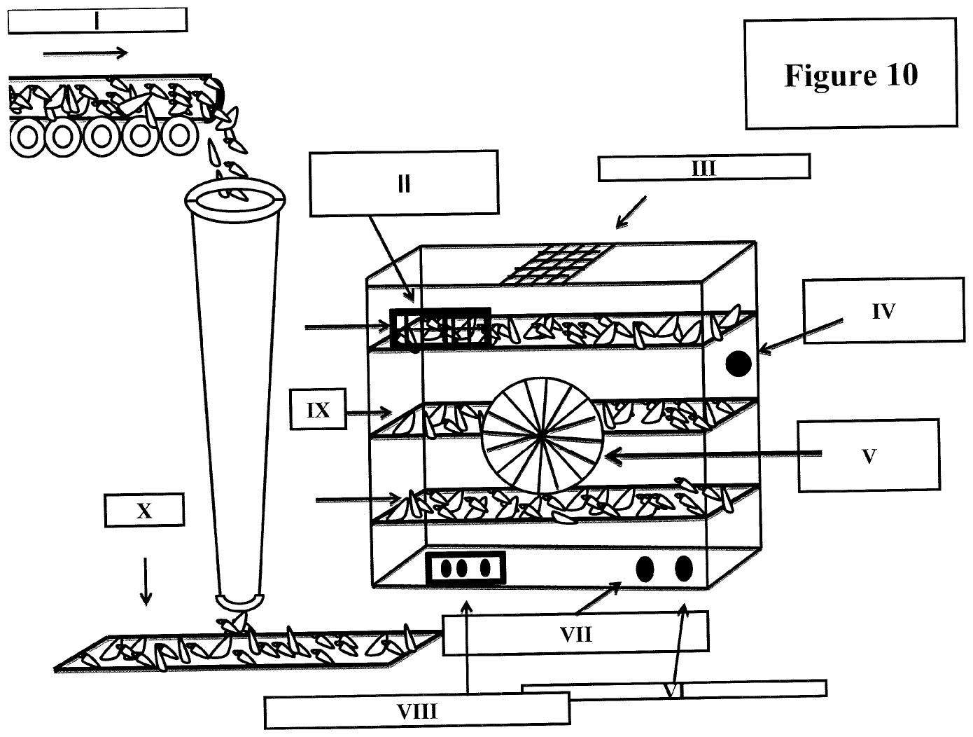

For example, we use the Response Surface Methodology (RSM) (FIG. 10) for a more efficient and uniform drying. Drying is achieved when optimization factors range as follows:
Air temperature is 40-60° C.,
Air velocity is 0.5-1.5 m/s and
Processing time is 240-480 minutes.

We achieve the desired coefficients for an indicative rate of 6% when the temperature is ˜51° C., the air velocity ˜1.00 m/s and the processing time is ˜299.00 minutes.

Then, from the dried volume of olive leaves, we collect some quantity to create our mixture.

The mixture consists of the dried olive leaf biomass (55-70% preferably), which is then sprayed with artificial moisture (preferably 11-12%) and inorganic and/or organic (vegetable, animal) and/or synthetic adhesives (preferably 30-45%).

Since moisture generally affects several characteristics (e.g. resilience, etc.), its percentage may vary depending on the desirable final material. It is worth mentioning that if the organic, inorganic or synthetic and even the combination of the two or three kind of adhesives require mixing—dilution with water (e.g. fish gelatine, etc.), then smaller quantities are injected during the spraying stage in order to achieve the desired moisture content for each use.

Its thickness generally varies with that of other commercial (non-ecological) panels (0.8-4 cm), but depending on its use it can be made at smaller (e.g. 0.2 cm-0.4 cm) or even larger dimensions (>4 cm).

When a colored material is desired, the addition of the dye to the mixture is carried out at the stage immediately after the drying procedure.

Depending on the adhesive (organic, synthetic or inorganic) to be used, the mixture is reintroduced into a dryer where it goes through a second drying stage. The drying temperature is between 55° C. and 65° C. (preferably between 60° C.) for a time period that may be between 30 and 100 minutes (preferably between 60 and 80 minutes).

Finally, the mixture is compressed (FIG. 1, FIG. 2) by using pressure systems above 25 bar (preferably 35-45 bar pressure), with or without heat (preferably 55-70° C.) for 15-60 minutes (preferably 22-28 minutes) to achieve the desirable density, etc.

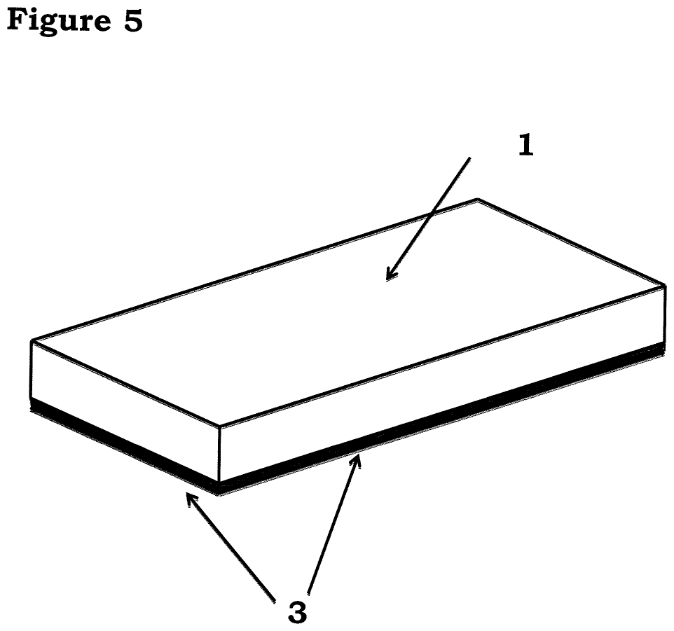

We can also use a substrate (in all shapes and dimensions) of a wide variety of materials, whether environmentally friendly or not (wood, resin, metal, other minerals, plastic, synthetic etc.), which can be placed as a base (FIG. 3, FIG. 5) and/or in the middle (FIG. 4, FIG. 6) and/or around the mixture (FIG. 7, FIG. 8).

The process of creating the olive leaf panels with the substrate is achieved either before the compression of the mixture (where the substrate is placed in the mixture and then compressed all together) or after this stage (once the olive leaf panel is created, we put the adhesive as well as the substrate and re-compress them all again). More often than not, the second procedure is followed when the substrate has no high mechanical resilience (fragile, etc.) so we do not need a lot of pressure bar to seal it.

The process of creating three-dimensional surfaces is implemented in the following indicative ways:

a) Creation of the mixture as mentioned above (a biomass of dry olives, moisture and adhesives), introduction to casting molds and compression (in the aforementioned modes, percentages and degrees) or using a substrate of all dimensions and shapes) (FIG. 3, FIG. 4, FIG. 8), or not (FIG. 2).

b) Creating a flat panel of large volume—thickness (of low or high density) either by using a substrate of all dimensions and shapes) (FIG. 3, FIG. 4, FIG. 8) or not (FIG. 2) and then by

using Cutting Machines and Laser (Computerized Numerical Control—CNC). Finally, we continue with the desirable processing.

c) Creation of flat or three-dimensional surfaces by vacuum infusion method (dry, green and/or dead olive leaves, insertion of adhesives, with or without moisture, under vacuum, with or not extra pressure) and then by using Cutting Machines and Laser (Computerized Numerical Control—CNC) we complete with the desirable processing.

The second and third methods are preferable, when we want our products to have high levels of standardization and precision and achieve identical replicas.

In conclusion, the surface of this innovative, eco-friendly olive leaf panel can be further processed, either according to conventional woodworking techniques (e.g., deburring, polishing, surface finish, drilling, etc.), of equivalent commercial panels (e.g. MDF, OSB, veneer, etc.) or art-related ones (Decoupage, wood carving, painting, etc.)

1.-10. (canceled)

11. A composition for manufacturing three-dimensional products comprising adhesives and water, the composition comprising leaves from olive trees.

12. The composition of claim 1, comprising 11-12% water, 30-45% adhesives and 55-70% leaves.

13. The composition of claim 1, wherein the leaves are a mixture of green and dead leaves.

14. The composition of claim 1, wherein the adhesives comprise fish-gelatine.

15. Method of manufacturing a three-dimensional product comprising the steps of:
a. collecting green and dead olive tree leaves,
b. washing and cleaning the leaves,
c. drying the leaves to a desired percentage of humidity,
d. adding an adhesive mixture,
e. creating a mixture of 11-12% water, 30-45% adhesive mixture and 55-70% leaves,
f. drying the mixture and
g. compressing the mixture.

16. The method according to claim 15, wherein the desired percentage of humidity of step c. is below 10%.

17. The method according to claim 15, wherein the desired percentage of humidity of step c. is 6%.

18. The method according to claim 15, wherein the drying of the leaves is done through air-drying.

19. The method according to claim 15, wherein the drying of the leaves is done through flash-drying.

20. The method according to claim 15, wherein the drying of the leaves is done through Response Surface Methodology, under an air-temperature of 40-60 degrees Celsius, an air-velocity of 0.5-1.5 m/s and processing time 240-480 minutes.

21. The method according to claim 15, wherein the drying of the leaves is done through Response Surface Methodology, under an air-temperature of approximately 51 degrees Celsius, an air-velocity of approximately 1 m/s and processing time of approximately 299 minutes.

22. The method according to claim 15, wherein the mixture is compressed above 25 bars with heat for 15-60 minutes.

23. The method according to claim 15, wherein the mixture is compressed with a pressure of 35-45 bars, with heat of 55-70° C., for 22-28 minutes.

24. The method according to claim 15, wherein the product is combined with a substrate base.
